(19) United States
(12) Patent Application Publication
(10) Pub. No.: US 2024/0204288 A1
(43) Pub. Date: Jun. 20, 2024

(54) ELECTROCHEMICAL CELL SYSTEMS WITH MULTI-CHAMBER COOLING DEVICES, AND METHODS OF PRODUCING THE SAME

(71) Applicant: 24M Technologies, Inc., Cambridge, MA (US)

(72) Inventor: Khosrow NEMATOLLAHI, Carmel, IN (US)

(21) Appl. No.: 18/539,706

(22) Filed: Dec. 14, 2023

Related U.S. Application Data
(60) Provisional application No. 63/433,234, filed on Dec. 16, 2022.

(51) Int. Cl. H01M 10/6554; H01M 10/651; H01M 10/6556; H01M 10/6561

(52) U.S. Cl. CPC H01M 10/6554; H01M 10/651; H01M 10/6556; H01M 10/6561; H01M 10/613

(57) ABSTRACT

Embodiments described herein relate to heat transfer plates and adjacent chambers for transferring heat away from electrochemical cells. In some aspects, an electrochemical cell system can include a cooling device with a first plate, a second plate coupled to the first plate to form a first outer chamber, a third plate coupled to the second plate to form an inner chamber, a fourth plate coupled to the third plate to form a second outer chamber, and a chamber return coupled to the first plate, the second plate, the third plate, and the fourth plate, the chamber return configured to guide fluid flow from the first outer chamber and the second outer chamber to the inner chamber. The electrochemical cell system includes a first electrochemical cell disposed on an outer surface of the first plate; and a second electrochemical cell disposed on an outer surface of the fourth plate.

### CROSS-REFERENCE TO RELATED APPLICATIONS

This application claims priority to and the benefit of U.S. Provisional Patent Application No. 63/433,234, filed Dec. 16, 2022 and titled, “Electrochemical Cell Systems with Multi-Chamber Cooling Devices, and Methods of Producing the Same,” the disclosure of which is hereby incorporated by reference in its entirety.

### TECHNICAL FIELD

Embodiments described herein relate to heat transfer in electrochemical cell systems.

### BACKGROUND

Heat generation in electrochemical cells is a safety issue that can have dangerous results. Thermal runaway can lead to fires and thermal decomposition of the electrochemical cell materials. Passing streams of air or other gases along the surfaces of electrochemical cells can draw heat away from the electrochemical cells, similar to how fans are applied to processors in computers. Flow paths of passing streams can be designed to maximize heat transfer out of electrochemical cells.

### SUMMARY

Embodiments described herein relate to heat transfer plates and adjacent chambers for transferring heat away from electrochemical cells. In some aspects, an electrochemical cell system can include a cooling device with a first plate, a second plate coupled to the first plate to form a first outer chamber, a third plate coupled to the second plate to form an inner chamber, a fourth plate coupled to the third plate to form a second outer chamber, and a chamber return coupled to the first plate, the second plate, the third plate, and the fourth plate, the chamber return configured to guide fluid flow from the first outer chamber and the second outer chamber to the inner chamber. The electrochemical cell system includes a first electrochemical cell disposed on an outer surface of the first plate, and a second electrochemical cell disposed on an outer surface of the fourth plate. In some embodiments, the first plate and/or the fourth plate can include dimples that induce turbulence in a fluid flowing through the first outer chamber and/or the second outer chamber.

### BRIEF DESCRIPTION OF THE DRAWINGS

FIG. 1 is a block diagram of an electrochemical cell system, according to an embodiment.

FIGS. 2A-2J are illustrations of a heat transfer device and various components thereof, according to an embodiment.

FIGS. 3A-3D are illustrations of a heat transfer device, and various components thereof, according to an embodiment.

FIGS. 4A-4D are illustrations of a heat transfer device, and various components thereof, according to an embodiment.

FIG. 5 is a flow diagram of a method of cooling an electrochemical cell system, according to an embodiment.

### DETAILED DESCRIPTION

Embodiments described herein relate to removing heat from electrochemical cells and arrays of electrochemical cells. Flow paths of cooling fluid between arrays of electrochemical cells can be designed to maximize heat transfer away from the electrochemical cells. A heat transfer device (e.g., a cooling device) can be positioned between two cells or arrays of cells and cooling fluid can flow through chambers in the heat transfer device. The heat transfer device can include inlet ports and inlet chambers, as well as outlet ports and outlet chambers. In some embodiments, a warming device can be positioned between two cells or arrays of cells.

Temperature gradients in electrochemical cells and electrochemical cell systems can have detrimental effects on cell capacity and capacity retention. Embodiments described herein can reduce temperature gradients in electrochemical cell systems. Embodiments described herein can include flowing cold fluid into two side chambers, such that the cold fluid is in contact with plates that are in contact with warm electrochemical cells. In some embodiments, the side chambers can include turbulizers and/or dimples, such as those described in U.S. Provisional Patent Application No. 63/416,774 (“the '774 application”), titled, “Heat Transfer Plates in Electrochemical Cell Systems, and Methods of Producing the Same,” the disclosure of which is hereby incorporated by reference in its entirety. The turbulizers and/or dimples can increase turbulence in the cold fluid to enhance heat transfer from the electrochemical cells to the cold fluid. The cold fluid warms up in the side chambers and becomes a warm fluid as it approaches a chamber return and reverses directions. After reversing directions, the fluid moves through an additional chamber between the two side chambers and exits the heat transfer device.

In some embodiments, a warming device can be positioned between two electrochemical cells or arrays of electrochemical cells if the electrochemical cells are cold. A hot fluid can be sent through the two side chambers of the warming device and fed back through the additional chamber between the two side chambers to exit the warming device.

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

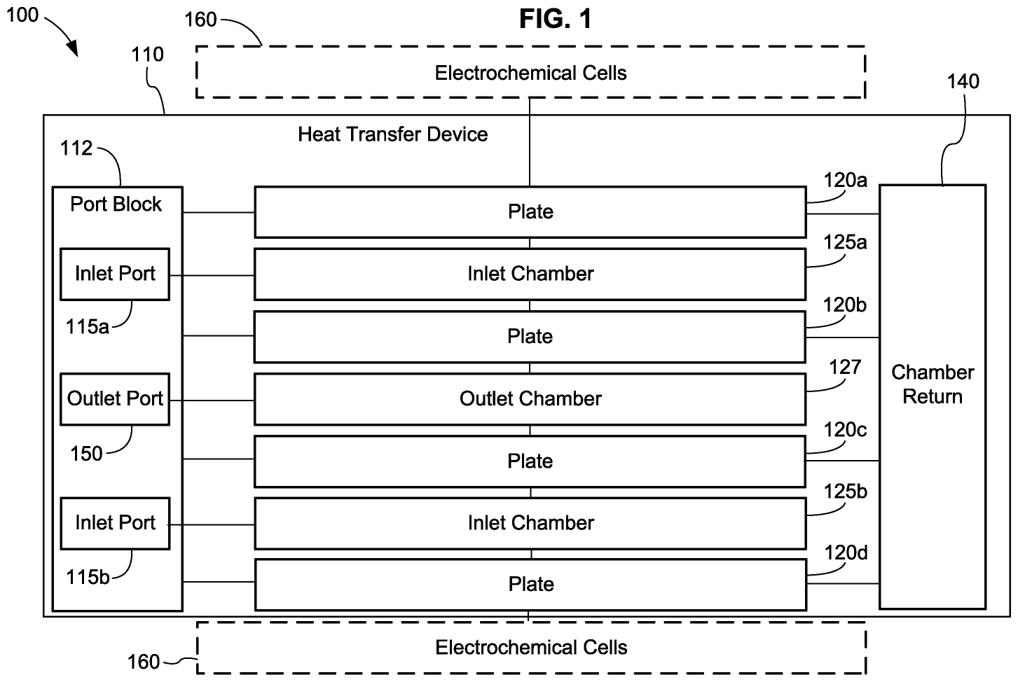

FIG. 1 is a block diagram of an electrochemical cell system 100, according to an embodiment. As shown, the electrochemical cell system 100 includes a heat transfer device 110. The heat transfer device 110 includes a port block 112 coupled to plates 120a, 120b, 120c, 120d (collectively referred to as plates 120). The plates 120 are coupled to a chamber return 140. The port block 112 includes inlet ports 115a, 115b (collectively referred to as inlet ports 115) and outlet port 150. The first plate 120a and the second plate 120b form a first inlet chamber 125a therebetween. The third plate 120c and the fourth plate 120d form a second inlet chamber 125b therebetween. The second plate 120b and the third plate 120c form an outlet chamber 127 therebetween. Electrochemical cells 160 are placed on either side of the heat transfer device 110 and heat is transferred between the electrochemical cells 160 and the heat transfer device 110.

In use, a heat transfer fluid (i.e., a cooling fluid or a heating fluid) flows through the inlet ports 115 and into the inlet chambers 125a, 125b (collectively inlet chambers 125). The heat transfer fluid flows through the inlet chambers 125 and the streams of heat transfer fluid merge into the outlet chamber 127 via the chamber return 140. The heat transfer fluid then flows through the outlet chamber 127 and out of the heat transfer device 110 via the outlet port 150.

As shown, the inlet ports 115 and the outlet port 150 are incorporated into the port block 112. The heat transfer fluid enters and exits the heat transfer device 110 via the port block 112.

In some embodiments, the heat transfer fluid can include a gas. In some embodiments, the heat transfer fluid can include a liquid. In some embodiments, the heat transfer fluid can include air.

In some embodiments, the heat transfer fluid can include an inert gas, such as nitrogen, argon, helium, carbon dioxide, or any combination thereof. In some embodiments, the heat transfer fluid can include a liquid that does not react with lithium. In some embodiments, the heat transfer fluid can include a non-aqueous electrolyte solvent.

In some embodiments, the heat transfer fluid can include a cooling fluid. In some embodiments, the heat transfer fluid can include a heating fluid. In some embodiments, upon entering the inlet ports 115, the heat transfer fluid can have a temperature of at least about −50° C., at least about −40° C., at least about −30° C., at least about −20° C., at least about −10° C., at least about 0° C., at least about 10° C., at least about 20° C., at least about 30° C., at least about 40° C., at least about 50° C., at least about 60° C., at least about 70° C., at least about 80° C., at least about 90° C., at least about 100° C., at least about 110° C., at least about 120° C., at least about 130° C., at least about 140° C., at least about 150° C., at least about 160° C., at least about 170° C., at least about 180° C., or at least about 190° C. In some embodiments, upon entering the inlet ports 115, the heat transfer fluid can have a temperature of no more than about 200° C., no more than about 190° C., no more than about 180° C., no more than about 170° C., no more than about 160° C., no more than about 150° C., no more than about 140° C., no more than about 130° C., no more than about 120° C., no more than about 110° C., no more than about 100° C., no more than about 90° C., no more than about 80° C., no more than about 70° C., no more than about 60° C., no more than about 50° C., no more than about 40° C., no more than about 30° C., no more than about 20° C., no more than about 10° C., no more than about 0° C., no more than about −10° C., no more than about −20° C., no more than about −30° C., or no more than about −40° C. Combinations of the above-referenced temperatures are also possible (e.g., at least about −50° C. and no more than about 200° C. or at least about 20° C. and no more than about 60° C.), inclusive of all values and ranges therebetween. In some embodiments, upon entering the inlet ports 115, the heat transfer fluid can have a temperature of about −50° C., about −40° C., about −30° C., about −20° C., about −10° C., about 0° C., about 10° C., about 20° C., about 30° C., about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., or about 200° C.

In some embodiments, upon exiting the outlet port 150, the heat transfer fluid can have a temperature of at least about −50° C., at least about −40° C., at least about −30° C., at least about −20° C., at least about −10° C., at least about 0° C., at least about 10° C., at least about 20° C., at least about 30° C., at least about 40° C., at least about 50° C., at least about 60° C., at least about 70° C., at least about 80° C., at least about 90° C., at least about 100° C., at least about 110° C., at least about 120° C., at least about 130° C., at least about 140° C., at least about 150° C., at least about 160° C., at least about 170° C., at least about 180° C., or at least about 190° C. In some embodiments, upon exiting the outlet port 150, the heat transfer fluid can have a temperature of is no more than about 200° C., no more than about 190° C., no more than about 180° C., no more than about 170° C., no more than about 160° C., no more than about 150° C., no more than about 140° C., no more than about 130° C., no more than about 120° C., no more than about 110° C., no more than about 100° C., no more than about 90° C., no more than about 80° C., no more than about 70° C., no more than about 60° C., no more than about 50° C., no more than about 40° C., no more than about 30° C., no more than about 20° C., no more than about 10° C., no more than about 0° C., no more than about −10° C., no more than about −20° C., no more than about −30° C., or no more than about −40° C. Combinations of the above-referenced temperatures are also possible (e.g., at least about −50° C. and no more than about 200° C. or at least about 20° C. and no more than about 60° C.), inclusive of all values and ranges therebetween. In some embodiments, upon exiting the outlet port 150, the heat transfer fluid can have a temperature of about −50° C., about −40° C., about −30° C., about −20° C., about −10° C., about 0° C., about 10° C., about 20° C., about 30° C., about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., or about 200° C.

In some embodiments, the margin of (temperature of heat transfer fluid entering inlet ports 115)—(temperature of heat transfer fluid exiting outlet port 150) can be at least about −50° C., at least about −40° C., at least about −30° C., at least about −20° C., at least about −10° C., at least about 0° C., at least about 10° C., at least about 20° C., at least about 30° C., at least about 40° C., at least about 50° C., at least about 60° C., at least about 70° C., at least about 80° C., or at least about 90° C. In some embodiments, the margin of (temperature of heat transfer fluid entering inlet ports 115)—(temperature of heat transfer fluid exiting outlet port 150) can be no more than about 100° C., no more than about 90° C., no more than about 80° C., no more than about 70° C., no more than about 60° C., no more than about 50° C., no more than about 40° C., no more than about 30° C., no more than about 20° C., no more than about 10° C., no more than about 0° C., no more than about −10° C., no more than about −20° C., no more than about −30° C., or no more than about −40° C. Combinations of the above-referenced margins are also possible (e.g., at least about −50° C. and no more than about 100° C. or at least about 10° C. and no more than about 60° C.), inclusive of all values and ranges therebetween. In some embodiments, the margin of (temperature of heat transfer fluid entering inlet ports 115)—(temperature of heat transfer fluid exiting outlet port 150) can be about −50° C., about −40° C., about −30° C., about −20° C., about −10° C., about 0° C., about 10° C., about 20° C., about 30° C., about 40° C., about 50° C., about 60° C., about 70° C., about 80° C., about 90° C., or about 100° C.

In some embodiments, the inlet ports 115 and/or the outlet port 150 can have smooth inner surfaces. In some embodiments, the inlet ports 115 and/or the outlet port 150 can have grooves, bumps, and/or dimples to turbulize the heat transfer fluid and enhance heat transfer. In some embodiments, the inlet ports 115 and/or the outlet port 150 can have a round shape, a rectangular shape, a square shape, an elliptical shape, a slot shape, or any other suitable shape or combinations thereof. In some embodiments, the inlet ports 115 and/or the outlet port 150 can follow a straight path. In some embodiments, the inlet ports 115 and/or the outlet port 150 can follow a tortuous path.

As shown, the inlet ports 115 and the inlet chambers 125 are located on the outer side of the heat transfer device 110 and extend along the length of the heat transfer device 110. The heat transfer fluid moves along the inlet chambers 125 while in contact with the plates 120. The plates 120 are in contact with the electrochemical cells 160. In some embodiments, the heat transfer fluid can draw heat from the plates 120, which draw heat from the electrochemical cells 160. In some embodiments, the heat transfer fluid can heat the plates 120, which heat the electrochemical cells 160. In some embodiments, the plates 120 can include dimples, such as those described in the '774 application.

The inlet chambers 125 interact with the chamber return 140 and the fluidic path of the heat transfer fluid redirects to the outlet chamber 127. The inlet chambers 125 are fluidically coupled to the outlet chamber 127 via the chamber return 140. In some embodiments, the outlet chamber 140 can have rounded surfaces to direct the fluid flow to the outlet chamber 127.

In some embodiments, the heat transfer fluid can be fed into the heat transfer device 110 via the outlet port 150 (i.e., the outlet port 150 can act as an inlet port). The heat transfer fluid can then flow through the outlet chamber 127 (i.e., the outlet chamber 127 can act as an inlet chamber). The heat transfer fluid can then reverse directions via the chamber return 140 and flow via the inlet chambers 125 (i.e., the inlet chambers 125 can act as outlet chambers) and then out of the heat transfer device 110 via the inlet ports 115 (i.e., the inlet ports 115 can act as outlet ports).

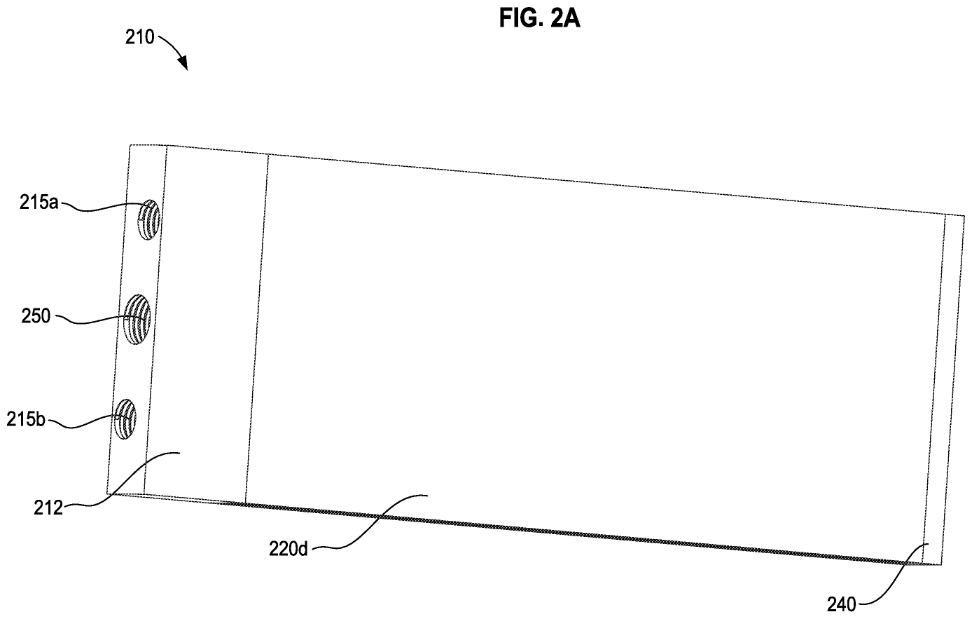

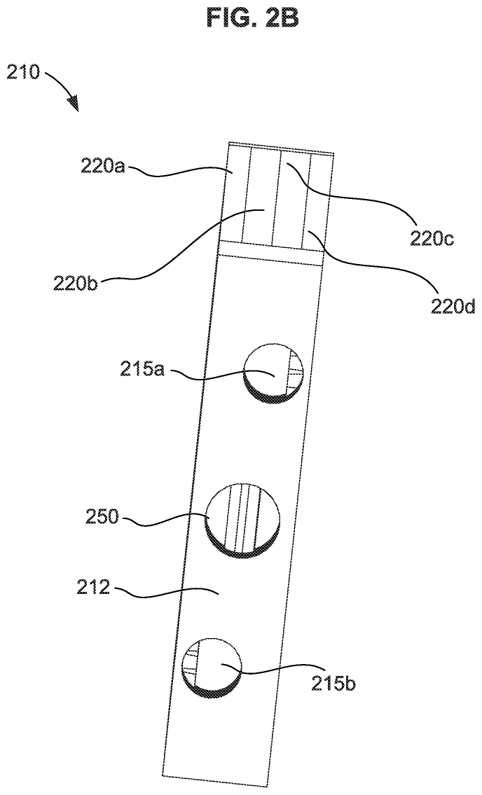

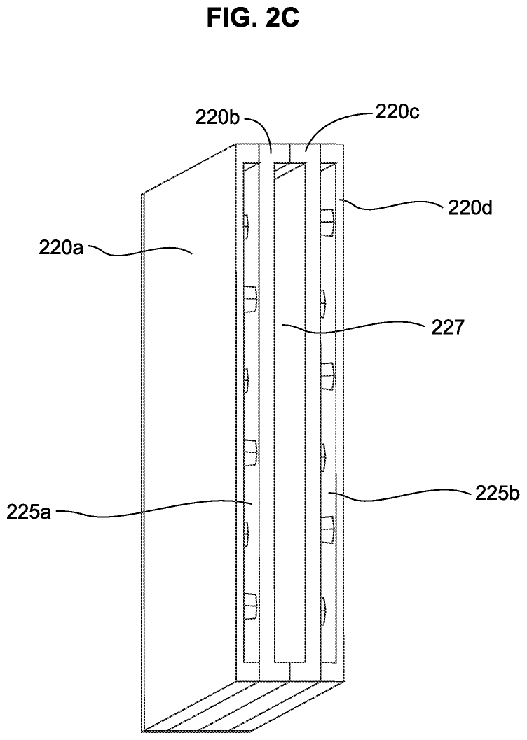

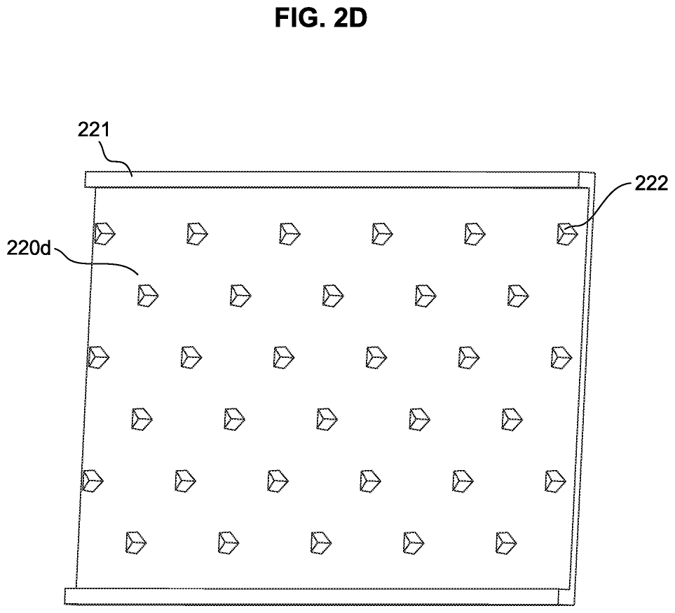

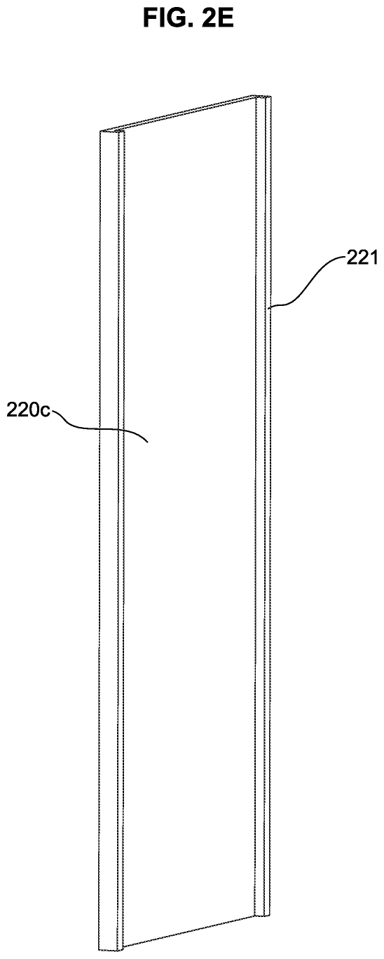

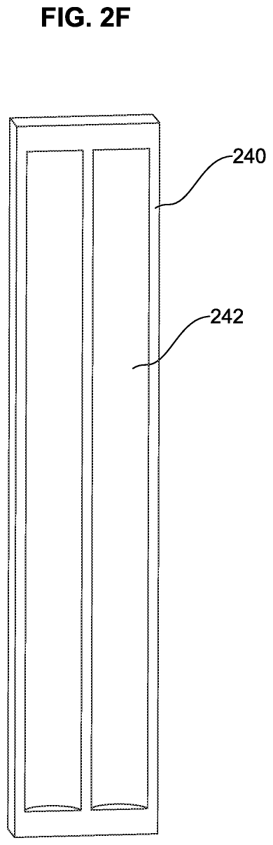

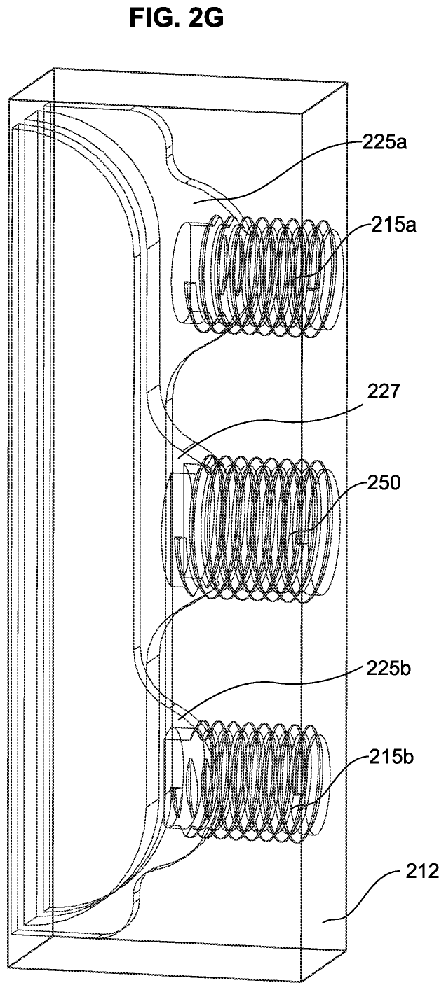

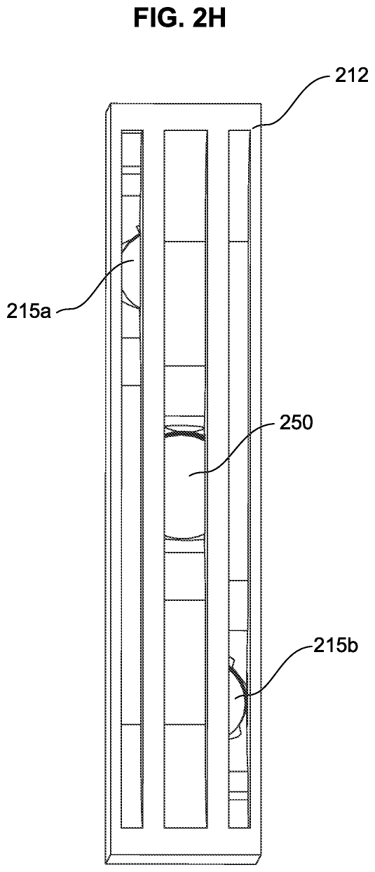

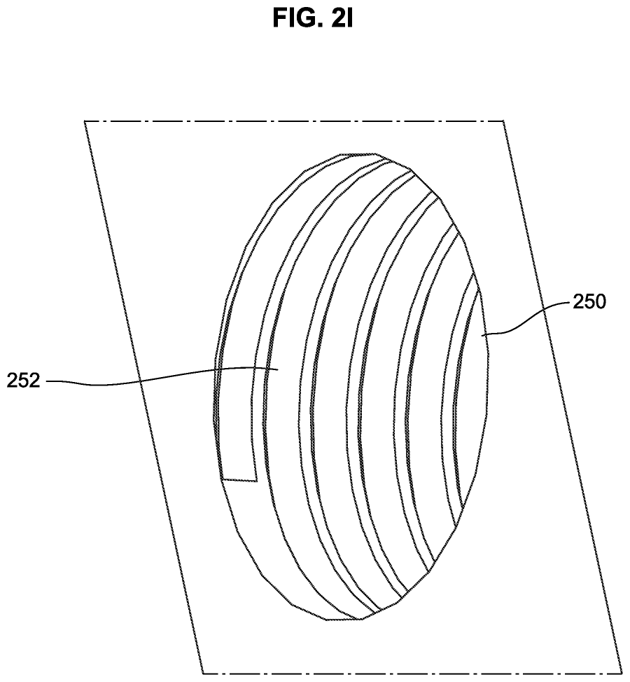

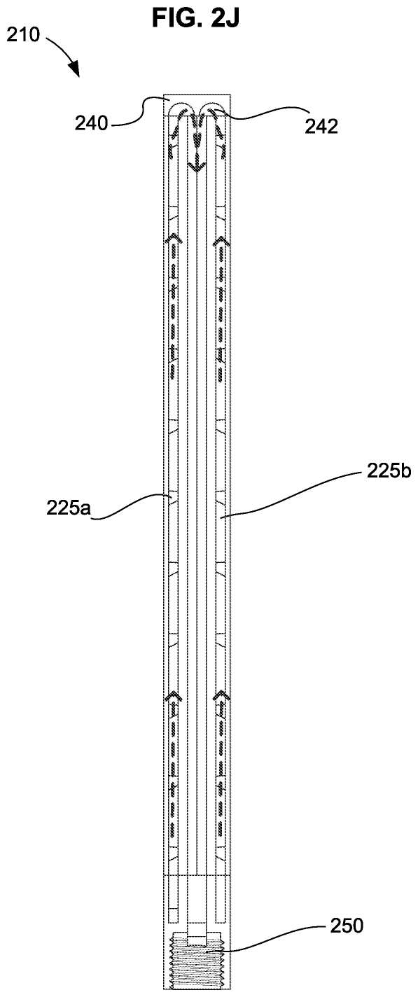

FIGS. 2A-2J are illustrations of a heat transfer device 210, according to an embodiment. As shown, the heat transfer device 210 includes a port block 212 with inlet ports 215a, 215b (collectively referred to as inlet ports 215) and an outlet port 250. The port block 212 is coupled to plates 220a, 220b, 220c, 220d (collectively referred to as plates 220). The plate 220a and the plate 220b form an inlet chamber 225a therebetween. The plate 220c and the plate 220d form an inlet chamber 225b therebetween. The plate 220b and the plate 220c form an outlet chamber 227 therebetween. The plates 220 each include ridges 221. The ridges 221 include contact surfaces for contact between the plates 220. The plate 220a and the plate 220d include dimples 222 thereon to induce turbulence in the inlet chambers 225a, 225b (collectively referred to as inlet chambers 225). The plates 220 are coupled to a chamber return 240. The chamber return 240 includes curved surfaces 242 for guiding flow of the heat transfer fluid from the inlet chambers 225 to the outlet chamber 227. The heat transfer fluid exits the heat transfer device 210 via the outlet port 250. In some embodiments, the heat transfer device 210, the port block 212, the inlet ports 215, the plates 220, the inlet chambers 225, the outlet chamber 227, the chamber return 240, and the outlet port 250 can be the same or substantially similar to the heat transfer device 110, the port block 112, the inlet ports 115, the plates 120, the inlet chambers 125, the outlet chamber 127, the chamber return 140, and the outlet port 150, as described above with reference to FIG. 1. Thus, certain aspects of the heat transfer device 210, the port block 212, the inlet ports 215, the plates 220, the inlet chambers 225, the outlet chamber 227, the chamber return 240, and the outlet port 250 are not described in greater detail herein.

FIG. 2A shows an auxiliary view of the heat transfer device 210 from the exterior. FIG. 2B shows a view of a proximal end of the heat transfer device 210 with the inlet ports 215 and the outlet port 250 visible. FIG. 2C shows a view of a portion of the heat transfer device 210 from the proximal end of the heat transfer device 210 with the port block 212 removed to show greater detail of the inlet chambers 225 and the outlet chamber 227. FIG. 2D shows the plate 220d with a ridge 221 and dimples 222. FIG. 2E shows the plate 220c with a ridge 221 and without dimples 222. FIG. 2F shows a detailed view of the chamber return 242 with the curved surface for guiding the flow of heat transfer fluid from the inlet chambers 225 to the outlet chamber 227. FIG. 2G shows a transparent view of the port block 212, such that the details of the inlet ports 215 and the outlet port 250, as well as their interactions with the inlet chambers 225 and the outlet chamber 227. FIG. 2H shows a view of the port block 212 from a distal side of the port block 212 with portions of the inlet ports 215 and the outlet port 250 visible. FIG. 2I shows a detailed view of the outlet port 250 with threading 252 visible. FIG. 2J shows a cross-sectional view of the heat transfer device 210 with the flow path of the heat transfer fluid visible.

As shown, the inlet ports 215 and the outlet port 250 include threading 252 for coupling to fluid feeds (not shown). In some embodiments, the inlet ports 215 can have diameters of at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 1.5 cm, at least about 2 cm, at least about 2.5 cm, at least about 3 cm, at least about 3.5 cm, at least about 4 cm, or at least about 4.5 cm. In some embodiments, the inlet ports 215 can have diameters of no more than about 5 cm, no more than about 4.5 cm, no more than about 4 cm, no more than about 3.5 cm, no more than about 3 cm, no more than about 2.5 cm, no more than about 2 cm, no more than about 1.5 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced diameters are also possible (e.g., at least about 1 mm and no more than about 5 mm or at least about 5 mm and no more than about 3 cm), inclusive of all values and ranges therebetween. In some embodiments, the inlet ports 215 can have diameters of about 1 mm, about 2 mm, about 3 mm, about 4 mm, about 5 mm, about 6 mm, about 7 mm, about 8 mm, about 9 mm, about 1 cm, about 1.5 cm, about 2 cm, about 2.5 cm, about 3 cm, about 3.5 cm, about 4 cm, about 4.5 cm, or about 5 cm.

In some embodiments, the outlet port 250 can have a diameter of at least about 2 mm, at least about 3 mm, at least about 4 mm, at least about 5 mm, at least about 6 mm, at least about 7 mm, at least about 8 mm, at least about 9 mm, at least about 1 cm, at least about 1 cm, at least about 2 cm, at least about 2 cm, at least about 3 cm, at least about 3 cm, at least about 4 cm, at least about 5 cm, at least about 6 cm, at least about 7 cm, at least about 8 cm, or at least about 9 cm. In some embodiments, the outlet port 250 can have a diameter of no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, or no more than about 3 mm. Combinations of the above-referenced diameters are also possible (e.g., at least about 2 mm and no more than about 10 cm or at least about 8 mm and no more than about 4 cm), inclusive of all values and ranges therebetween. In some embodiments, the outlet port 250 can have diameters of about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm.

As shown, the outlet port 250 is aligned parallel with the inlet ports 215, such that heat transfer fluid exiting the outlet port 250 exits the heat transfer device flowing in the opposite direction from heat transfer fluid entering the inlet ports 215. In other words, a center line extending axially from the outlet port 250 is parallel to center lines extending axially from the inlet ports 215. In some embodiments, the center line extending axially from the outlet port 250 can form an angle with the center lines extending axially from the inlet ports 215 of about 5° C., about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C., or about 90° C., inclusive of all values and ranges therebetween.

As shown, the inlet port 215a is oriented parallel to the inlet port 215b. In some embodiments, the center line extending axially from the inlet port 215a can form an angle with the center line extending axially from the inlet port 215b of about 5° C., about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C., or about 90° C., inclusive of all values and ranges therebetween. As shown, the inlet ports 215 and the outlet port 250 are incorporated into a single surface of the port block 212. In some embodiments, the inlet ports 215 can be incorporated into a first surface of the port block 212 and the outlet port 250 can be incorporated into a second surface of the port block 212. In some embodiments, the second surface can be perpendicular or approximately perpendicular to the first surface.

In some embodiments, the heat transfer device 210 can include a fluid distributor (not shown) that distributes heat transfer fluid throughout the height of the heat transfer device 210 upon entering the heat transfer device 210. Upon entering the inlet ports 215, the heat transfer fluid can be at least partially confined to the vertical position of the heat transfer device 210 where the heat transfer fluid initially entered the heat transfer device 210. This can lead to temperature gradients in the heat transfer device 210 and in the adjacent electrochemical cells, which can negatively affect the energy capacity of the electrochemical cells. The fluid distributor can distribute the heat transfer fluid upon entry into the heat transfer device 210. In some embodiments, the fluid distributor can include one or more pegs or protuberances attached to the inner walls of the plates 220 that guide the flow path of the heat transfer fluid upon entering the heat transfer device 210. In some embodiments, the fluid distributor can include one or more pegs or protuberances attached to the inner walls of the port block 212.

In some embodiments, the plates 220 can have a thickness of at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, or at least about 4 cm. In some embodiments, the plates 220 can have a thickness of no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, or no more than about 200 μm. Combinations of the above-referenced thicknesses are also possible (e.g., at least about 100 μm and no more than about 5 cm or at least about 500 μm and no more than about 5 mm), inclusive of all values and ranges therebetween. In some embodiments, the plates 220 can have a thickness of about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, or about 5 cm.

In some embodiments, the material of the plates 220 may be a metal, alloy, ceramic, composite, polymer or combinations thereof. In some embodiments, the material of the plates 220 may include metal-matrix composite, metal-ceramic composites or carbon composites. In some embodiments, the material of the plates 220 may include Carbon Steel, Copper, Nickel, Cupro-Nickel (90/10 Cupro-Nickel, 80/20 Cupro-Nickel, 70/30 Cupro-Nickel), Inconel, Incoloy, Admiralty Brass, Stainless Steel (304/L Stainless Steel, 316/L Stainless Steel, 317/L Stainless Steel, 321/L Stainless Steel), Duplex Steel, Alloy 20 (Nickel-Chromium-Molybdenum), Monel 400, Hastelloy B, Hastelloy C, Titanium, Aluminum, Nickel 200, Al-6XN Superaustenitic Stainless Steel, Brass (70Cu-30 Zn), Aluminum Brass (76Cu-22Zn-2Al), Red Brass (85Cu-15Zn), Carbon-moly (0.5Mo), Chrome-moly steel, Lead, Zinc, Tungsten, Silicon Carbide, Aluminum Nitride, Graphite, Polypropylene or combinations thereof.

In some embodiments, the material of the plates 220 may have a thermal conductivity of at least about 0.1 W/m-K, at least about 0.5 W/m-K, 1 W/m-K, at least about 5 W/m-K, 10 W/m-K, at least about 50 W/m-K, 100 W/m-K, at least about 500 W/m-K, at least about 1,000 W/m-K, or at least about 2,500 W/m-K. In some embodiments, the material of the plates 220 may have a thermal conductivity of no more than about 5,000 W/m-K, no more than about 2,500 W/m-K, no more than about 1,000 W/m-K, no more than about 500 W/m-K, no more than about 100 W/m-K, no more than about 50 W/m-K, no more than about 10 W/m-K, no more than about 5 W/m-K, no more than about 1 W/m-K, or no more than about 0.5 W/m-K.

In some embodiments, the inlet chambers 225 can have a length (i.e., a distance from the port block 212 to the chamber return 240) of at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, at least about 90 cm, at least about 1 m, at least about 1.5 m, at least about 2 m, at least about 2.5 m, at least about 3 m, at least about 3.5 m, at least about 4 m, or at least about 4.5 m. In some embodiments, the inlet chambers 225 can have a length of no more than about 5 m, no more than about 4.5 m, no more than about 4 m, no more than about 3.5 m, no more than about 3 m, no more than about 2.5 m, no more than about 2 m, no more than about 1.5 m, no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, or no more than about 2 cm. Combinations of the above-referenced lengths of the inlet chambers 225 are also possible (e.g., at least about 2 cm and no more than about 5 m or at least about 5 cm and no more than about 2 m), inclusive of all values and ranges therebetween. In some embodiments, the inlet chambers 225 can have a length of about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, about 1 m, about 1.5 m, about 2 m, about 2.5 m, about 3 m, about 3.5 m, about 4 m, about 4.5 m, or about 5 m.

In some embodiments, the inlet chambers 225 can have widths (i.e., distances between plates 220) of at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, or at least about 9 cm. In some embodiments, the inlet chambers 225 can have widths of no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, or no more than about 200 μm. Combinations of the above-referenced widths are also possible (e.g., at least about 100 μm and no more than about 10 cm or at least about 1 mm and no more than about 1 cm), inclusive of all values and ranges therebetween. In some embodiments, the inlet chambers 225 can have widths of about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm.

In some embodiments, the aspect ratio of the length of the inlet chambers 225 to the width of the inlet chambers 225 can be at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, at least about 900, at least about 1,000, or at least about 1,500. In some embodiments, the aspect ratio of the length of the inlet chambers 225 to the width of the inlet chambers 225 can be no more than about 2,000, no more than about 1,500, no more than about 1,000, no more than about 900, no more than about 800, no more than about 700, no more than about 600, no more than about 500, no more than about 400, no more than about 300, no more than about 200, no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, or no more than about 3. Combinations of the above-referenced aspect ratios are also possible (e.g., at least about 2 and no more than about 2,000 or at least about 50 and no more than about 500), inclusive of all values and ranges therebetween. In some embodiments, the aspect ratio of the length of the inlet chambers 225 to the width of the inlet chambers 225 can be about 2, about 3, about 4, about 5, about 6, about 7, about 8, about 9, about 10, about 20, about 30, about 40, about 50, about 60, about 70, about 80, about 90, about 100, about 200, about 300, about 400, about 500, about 600, about 700, about 800, about 900, about 1,000, about 1,500, or about 2,000.

The outlet chamber 227 extends along the length of the inlet chambers 225. In some embodiments, the outlet chamber 227 can have a length (i.e., a distance from the port block 212 to the chamber return 240) of at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, at least about 90 cm, at least about 1 m, at least about 1.5 m, at least about 2 m, at least about 2.5 m, at least about 3 m, at least about 3.5 m, at least about 4 m, or at least about 4.5 m. In some embodiments, the outlet chamber 227 can have a length of no more than about 5 m, no more than about 4.5 m, no more than about 4 m, no more than about 3.5 m, no more than about 3 m, no more than about 2.5 m, no more than about 2 m, no more than about 1.5 m, no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, or no more than about 2 cm. Combinations of the above-referenced lengths of the outlet chamber 227 are also possible (e.g., at least about 2 cm and no more than about 5 m or at least about 5 cm and no more than about 2 m), inclusive of all values and ranges therebetween. In some embodiments, the outlet chamber 227 can have a length of about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, about 1 m, about 1.5 m, about 2 m, about 2.5 m, about 3 m, about 3.5 m, about 4 m, about 4.5 m, or about 5 m.

In some embodiments, the outlet chamber 227 can have widths (i.e., distances between plates 220) of at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, or at least about 9 cm. In some embodiments, the outlet chamber 227 can have widths of no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, or no more than about 200 μm. Combinations of the above-referenced widths are also possible (e.g., at least about 100 [symbol] m and no more than about 10 cm or at least about 1 mm and no more than about 1 cm), inclusive of all values and ranges therebetween. In some embodiments, the outlet chamber 227 can have widths of about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm.

In some embodiments, the aspect ratio of the length of the outlet chamber 227 to the width of the outlet chamber 227 can be at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, at least about 900, at least about 1,000, or at least about 1,500. In some embodiments, the aspect ratio of the length of the outlet chamber 227 to the width of the outlet chamber 227 can be no more than about 2,000, no more than about 1,500, no more than about 1,000, no more than about 900, no more than about 800, no more than about 700, no more than about 600, no more than about 500, no more than about 400, no more than about 300, no more than about 200, no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, or no more than about 3. Combinations of the above-referenced aspect ratios are also possible (e.g., at least about 2 and no more than about 2,000 or at least about 50 and no more than about 500), inclusive of all values and ranges therebetween. In some embodiments, the aspect ratio of the length of the outlet chamber 227 to the width of the outlet chamber 227 can be about 2, about 3, about 4, about 5, about 6, about 7, about 8, about 9, about 10, about 20, about 30, about 40, about 50, about 60, about 70, about 80, about 90, about 100, about 200, about 300, about 400, about 500, about 600, about 700, about 800, about 900, about 1,000, about 1,500, or about 2,000.

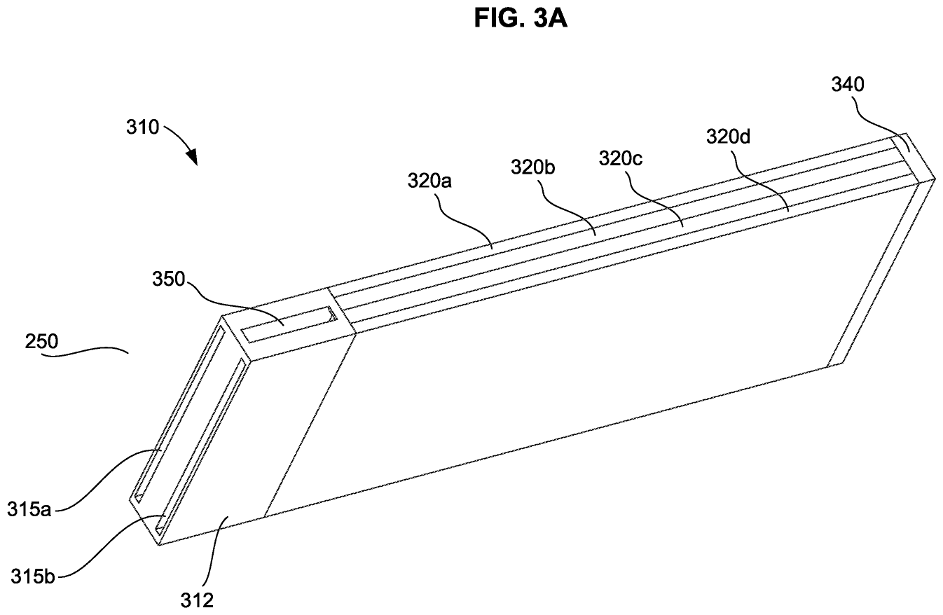

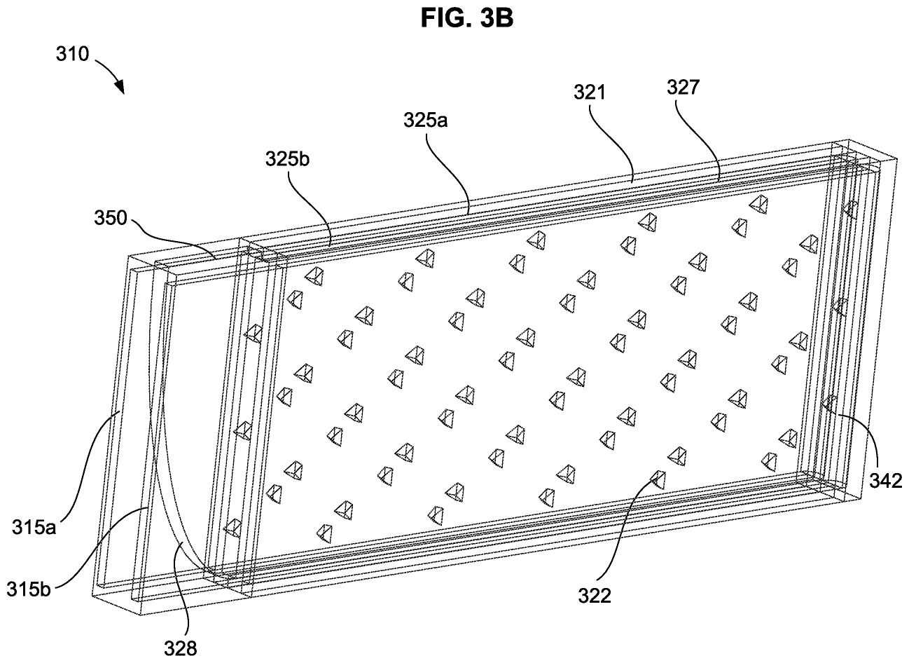

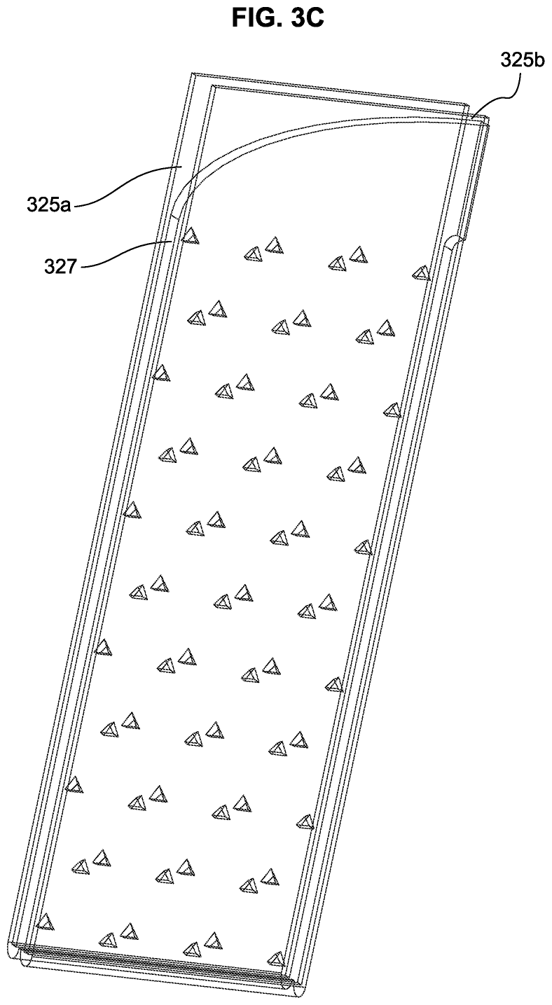

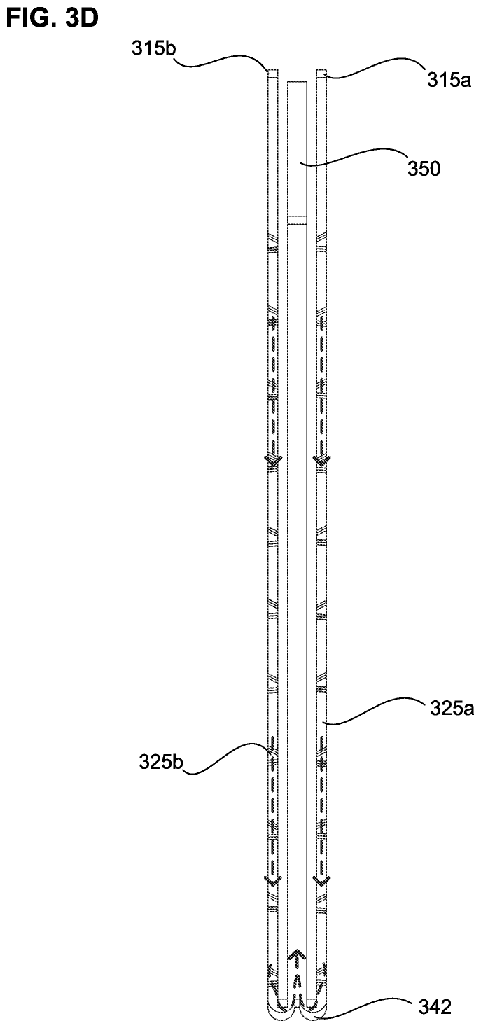

FIGS. 3A-3D are illustrations of a heat transfer device 310, and various components thereof, according to an embodiment. As shown, the heat transfer device 310 includes a port block 312 with inlet ports 315a, 315b (collectively referred to as inlet ports 315) and an outlet port 350. The port block 312 is coupled to plates 320a, 320b, 320c, 320d (collectively referred to as plates 320). The plate 320a and the plate 320b form an inlet chamber 325a therebetween. The plate 320c and the plate 320d form an inlet chamber 325b therebetween. The plate 320b and the plate 320c form an outlet chamber 327 therebetween. The plates 320 each include ridges 321. The ridges 321 include contact surfaces for contact between the plates 320. The plate 320a and the plate 320d include dimples 322 thereon to induce turbulence in the inlet chambers 325a, 325b (collectively referred to as inlet chambers 325). The plates 320 are coupled to a chamber return 340. The chamber return 340 includes curved surfaces 342 for guiding flow of the heat transfer fluid from the inlet chambers 325 to the outlet chamber 327. The outlet chamber 327 includes a curved surface 328 to guide heat transfer fluid out of the heat transfer device 310 via the outlet port 350. The heat transfer fluid exits the heat transfer device 310 via the outlet port 350. In some embodiments, the heat transfer device 310, the port block 312, the inlet ports 315, the plates 320, the ridges 321, the dimples 322, the inlet chambers 325, the outlet chamber 327, the chamber return 340, the curved surfaces 342, and the outlet port 350 can be the same or substantially similar to the heat transfer device 210, the port block 212, the inlet ports 215, the plates 220, the ridges 221, the dimples 222, the inlet chambers 225, the outlet chamber 227, the chamber return 240, the curved surfaces 242, and the outlet port 250, as described above with reference to FIGS. 2A-2J. Thus, certain aspects of the heat transfer device 310, the port block 312, the inlet ports 315, the plates 320, the ridges 321, the dimples 322, the inlet chambers 325, the outlet chamber 327, the chamber return 340, the curved surfaces 342, and the outlet port 350 are not described in greater detail herein.

FIG. 3A shows an auxiliary view of the heat transfer device 310. FIG. 3B shows a transparent view of the heat transfer device 310, such that fluid flow paths through the heat transfer device 310 are visible. FIG. 3C shows the negative space between the components of the heat transfer device 310. FIG. 3D shows a cross-sectional view of the heat transfer device 310 with the flow path of the heat transfer fluid visible.

As shown, the inlet ports 315 are incorporated into a first surface of the port block 312 and the outlet port 350 is incorporated into a second surface of the port block 312. As shown, the second surface is approximately perpendicular to the first surface. This orientation can be employed in electrochemical cell systems, in which a heat transfer fluid enters the heat transfer device 310 from a first vessel and exits the heat transfer device 310 into a second vessel. This can be beneficial for keeping incoming heat transfer fluid separate from outgoing heat transfer fluid.

In some embodiments, the angle formed between the inlet ports 315 and the outlet port 350 can be at least about 45°, at least about 50°, at least about 55°, at least about 60°, at least about 65°, at least about 70°, at least about 75°, at least about 80°, at least about 85°, at least about 90°, at least about 95°, at least about 100°, at least about 105°, at least about 110°, at least about 115°, at least about 120°, at least about 125°, or at least about 130°. In some embodiments, the angle formed between the inlet ports 315 and the outlet port 350 can be no more than about 135°, no more than about 130°, no more than about 125°, no more than about 120°, no more than about 115°, no more than about 110°, no more than about 105°, no more than about 100°, no more than about 95°, no more than about 90°, no more than about 85°, no more than about 80°, no more than about 75°, no more than about 70°, no more than about 65°, no more than about 60°, no more than about 55°, of no more than about 50°. Combinations of the above-referenced angles are also possible (e.g., at least about 450 and no more than about 1350 or at least about 800 and no more than about 1000), inclusive of all values and ranges therebetween. In some embodiments, the angle formed between the inlet ports 315 and the outlet port 350 can be about 45°, about 50°, about 55°, about 60°, about 65°, about 70°, about 75°, about 80°, about 85°, about 90°, about 95°, about 100°, about 105°, about 110°, about 115°, about 120°, about 125°, about 130°, or about 135°.

As shown, the inlet ports 315 are long slits having approximately the same width and height dimensions as the inlet chambers 315. In some embodiments, the inlet ports 315 can have height dimensions of about 10%, about 20%, about 30%, about 40%, about 50%, about 60%, about 70%, about 80%, or about 90% of the height dimensions of the inlet chambers 325. In some embodiments, the inlet ports 315 can have width dimensions of about 10%, about 20%, about 30%, about 40%, about 50%, about 60%, about 70%, about 80%, or about 90% of the width dimensions of the inlet chambers 325.

As shown, the outlet chamber 327 is coupled to the outlet port 350 via the curved surface 328. The curved surface 328 guides the flow of heat transfer fluid as the heat transfer fluid exits the heat transfer device 310. As shown, the outlet port 350 has a slot shape. In some embodiments, the outlet port 350 can have a length (i.e., a dimension along the travel direction of the heat transfer fluid) of at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 15 cm, at least about 20 cm, at least about 25 cm, at least about 30 cm, at least about 35 cm, at least about 40 cm, or at least about 45 cm. In some embodiments, the outlet port 350 can have a length of no more than about 50 cm, no more than about 45 cm, no more than about 40 cm, no more than about 35 cm, no more than about 30 cm, no more than about 25 cm, no more than about 20 cm, no more than about 15 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced lengths are also possible (e.g., at least about 1 mm and no more than about 50 cm or at least about 5 mm and no more than about 10 cm), inclusive of all values and ranges therebetween. In some embodiments, the outlet port 350 can have a length (i.e., a dimension along the travel direction of the heat transfer fluid) of about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 15 cm, about 20 cm, about 25 cm, about 30 cm, about 35 cm, about 40 cm, about 45 cm, or about 50 cm.

In some embodiments, the outlet port 350 can have a length of at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, or at least about 75% of the full length of the heat transfer device 310. In some embodiments, the outlet port 350 can have a length of no more than about 80%, no more than about 75%, no more than about 70%, no more than about 65%, no more than about 55%, no more than about 50%, no more than about 45%, no more than about 40%, no more than about 35%, no more than about 30%, no more than about 25%, no more than about 20%, no more than about 15%, no more than about 10%, no more than about 9%, no more than about 8%, no more than about 7%, no more than about 6%, no more than about 5%, no more than about 4%, no more than about 3%, or no more than about 2% of the full length of the heat transfer device 310. Combinations of the above-referenced percentages are also possible (e.g., at least about 1% and no more than about 80% or at least about 10% and no more than about 60%), inclusive of all values and ranges therebetween. In some embodiments, the outlet port 350 can have a length of about 1%, about 2%, about 3%, about 4%, about 5%, about 6%, about 7%, about 8%, about 9%, about 10%, about 15%, about 20%, about 25%, about 30%, about 35%, about 40%, about 45%, about 50%, about 55%, about 60%, about 65%, about 70%, about 75%, or about 80% of the full length of the heat transfer device 310.

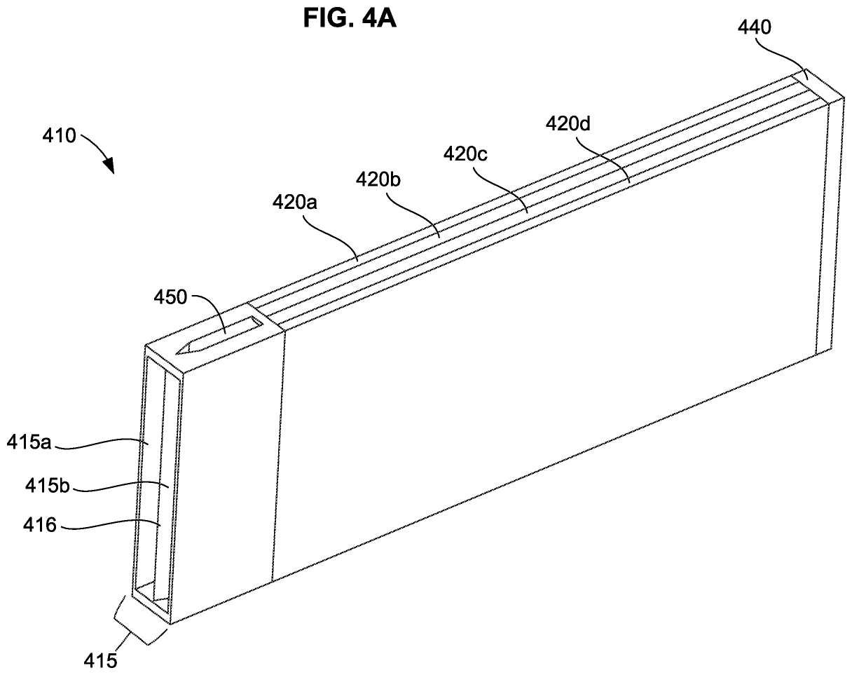

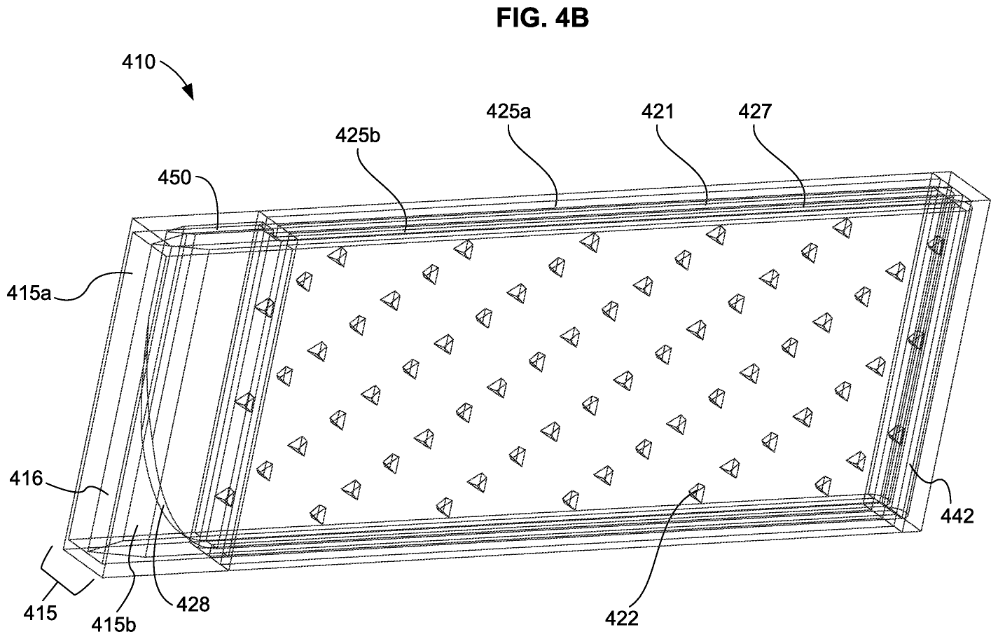

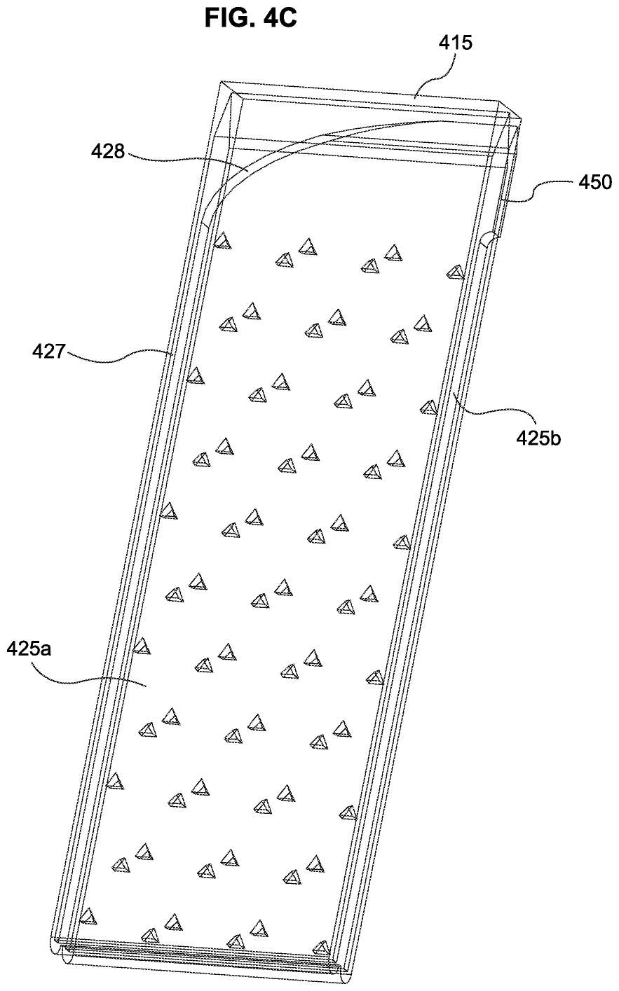

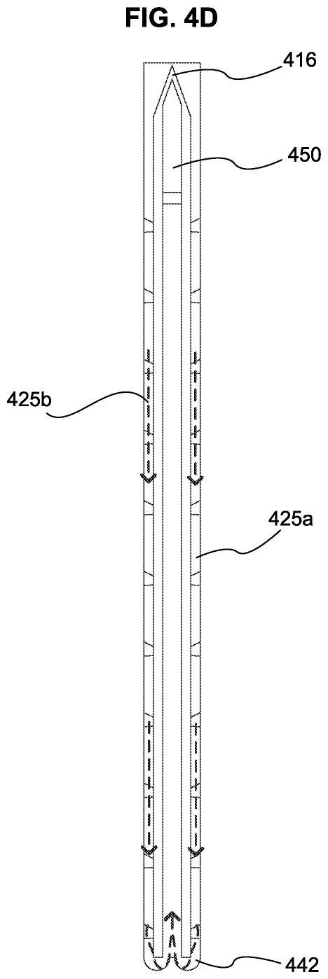

FIGS. 4A-4D are illustrations of a heat transfer device 410, and various components thereof, according to an embodiment. As shown, the heat transfer device 410 includes a port block 412 with an inlet port 415 that splits into sub-inlet ports 415a, 415b via a splitter 416. The port block 412 also includes an outlet port 450. The port block 412 is coupled to plates 420a, 420b, 420c, 420d (collectively referred to as plates 420). The plate 420a and the plate 420b form an inlet chamber 425a therebetween. The plate 420c and the plate 420d form an inlet chamber 425b therebetween. The plate 420b and the plate 420c form an outlet chamber 427 therebetween. The plates 420 each include ridges 421. The ridges 421 include contact surfaces for contact between the plates 420. The plate 420a and the plate 420d include dimples 422 thereon to induce turbulence in the inlet chambers 425a, 425b (collectively referred to as inlet chambers 425). The plates 420 are coupled to a chamber return 440. The chamber return 440 includes curved surfaces 442 for guiding flow of the heat transfer fluid from the inlet chambers 425 to the outlet chamber 427. The outlet chamber 427 includes a curved surface 428 to guide heat transfer fluid out of the heat transfer device 410 via the outlet port 450. The heat transfer fluid exits the heat transfer device 410 via the outlet port 450. In some embodiments, the heat transfer device 410, the port block 312, the sub-inlet ports 415a, 415b, the plates 420, the ridges 421, the dimples 422, the inlet chambers 425, the outlet chamber 427, the curved surface 428, the chamber return 440, the curved surfaces 442, and the outlet port 450 can be the same or substantially similar to the heat transfer device 310, the port block 312, the inlet ports 315a, 315b, the plates 320, the ridges 321, the dimples 322, the inlet chambers 325, the outlet chamber 327, the curved surface 328, the chamber return 340, the curved surfaces 342, and the outlet port 350, as described above with reference to FIGS. 3A-3D. Thus, certain aspects of the heat transfer device 410, the port block 412, the sub-inlet ports 415a, 415b, the plates 420, the ridges 421, the dimples 422, the inlet chambers 425, the outlet chamber 427, the curved surface 428, the chamber return 440, the curved surfaces 442, and the outlet port 450 are not described in greater detail herein.

FIG. 4A shows an auxiliary view of the heat transfer device 410. FIG. 4B shows a transparent view of the heat transfer device 410, such that fluid flow paths through the heat transfer device 410 are visible. FIG. 4C shows the negative space between the components of the heat transfer device 410. FIG. 4D shows a cross-sectional view of the heat transfer device 410 with the flow path of the heat transfer fluid visible.

In use, a heat transfer fluid flows into the heat transfer device 410 via the inlet port 415 and is split into the sub-inlet ports 415a, 415b upon contact with the splitter 416. The heat transfer fluid then enters the inlet chambers 425 via the sub-inlets 415a, 415b and flows to the outlet chamber 427 via the chamber return 440. The heat transfer fluid then exits the heat transfer device 410 via the outlet port 450. As shown, the splitter 416 shapes the outlet port 450. In other words, the outlet port 450 has an angled surface corresponding to the shape of the splitter 416. The material of the heat transfer device 410 has a sharp surface on both the inflow side and the outflow side. In some embodiments, the material of the heat transfer device 410 can be rounded or smoother on the outflow side.

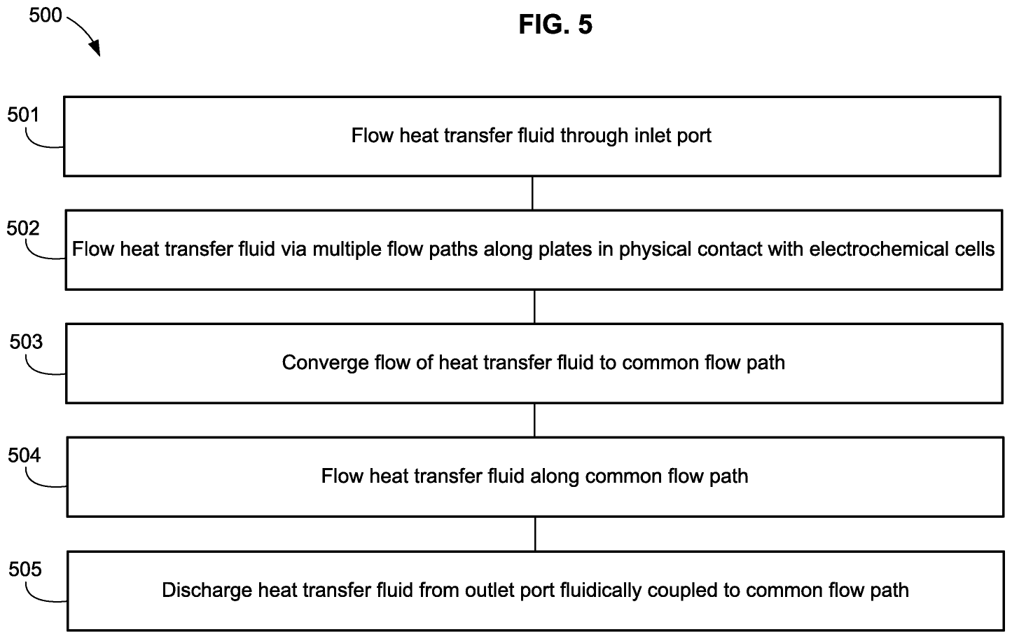

FIG. 5 is a flow diagram of a method 500 of cooling an electrochemical cell system, according to an embodiment. As shown, the method 500 includes flowing a heat transfer fluid through an inlet port at step 501, flowing the heat transfer fluid via multiple flow paths along plates in physical contact with electrochemical cells at step 502, converging the flow of the heat transfer fluid to a common flow path at step 503, flowing the heat transfer fluid along the common flow path at step 504, and discharging the heat transfer fluid from an outlet port fluidically coupled to the common flow path at step 505.

Step 501 includes flowing the heat transfer fluid through an inlet port. In some embodiments, the heat transfer fluid can include a cooling fluid. In some embodiments, the heat transfer fluid can include a heating fluid. In some embodiments, step 501 can include flowing the heat transfer fluid through multiple inlet ports. In some embodiments, step 501 can include splitting the heat transfer fluid into multiple flow paths upon entering the inlet port.

Step 502 includes flowing the heat transfer fluid via multiple flow paths along plates in physical contact with electrochemical cells. When the heat transfer fluid is a cooling fluid, it draws heat away from the electrochemical cells. When the heat transfer fluid is a heating fluid, it transfers heat to the electrochemical cells. Step 503 includes converging the flow of the heat transfer fluid to a common flow path. In some embodiments, the converging can be via a chamber return.

Step 504 includes flowing the heat transfer fluid along the common flow path. The common flow path can be formed by plates. In some embodiments, the common flow path can be between the multiple flow paths referenced in step 502. In some embodiments, the fluid can flow in the opposite direction along the common flow path, compared to the direction the fluid flowed during step 502. Step 505 includes discharging the heat transfer fluid from an outlet port fluidically coupled to the common flow path. In some embodiments, the outlet port can be integrated into the same surface as the inlet port referenced in step 501. In some embodiments, the outlet port can be integrated into a different surface from the inlet port referenced in step 501.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/of” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical cell system, comprising:
a heat transfer device, comprising:
a first plate;
a second plate coupled to the first plate to form a first outer chamber;
a third plate coupled to the second plate to form an inner chamber;
a fourth plate coupled to the third plate to form a second outer chamber; and
a chamber return coupled to the first plate, the second plate, the third plate, and the fourth plate, the chamber return configured to guide fluid flow from the first outer chamber and the second outer chamber to the inner chamber;
a first electrochemical cell disposed on an outer surface of the first plate; and
a second electrochemical cell disposed on an outer surface of the fourth plate.

2. The electrochemical cell system of claim 1, wherein at least one of the first plate or the fourth plate include dimples configured to induce turbulence in a fluid flowing through the first outer chamber and/or the second outer chamber.

3. The electrochemical cell system of claim 1, further comprising:
at least one additional electrochemical cell disposed on the outer surface of the first plate; and
at least one additional electrochemical cell disposed on the outer surface of the second plate.

4. The electrochemical cell system of claim 1, further comprising:
a first inlet port fluidically coupled to the first outer chamber;
a second inlet port fluidically coupled to the second outer chamber; and
an outlet port fluidically coupled to the inner chamber.

5. The electrochemical cell system of claim 4, wherein the at least one of the first inlet port, the second inlet port, and the third inlet port includes a groove configured to induce turbulence.

6. The electrochemical cell of claim 4, wherein the first inlet port, the second inlet port, and the outlet port are each integrated into a port block, the port block coupled to the first plate, the second plate, the third plate, and the fourth plate.

7. The electrochemical cell of claim 6, wherein the outlet port is approximately orthogonal to the first inlet port and the second inlet port.

8. The electrochemical cell system of claim 1, wherein the chamber return includes two curved surfaces configured to direct the fluid flow.

9. The electrochemical cell of claim 1, further comprising:
a splitter configured to divide a fluid flow between the first outer chamber and the second outer chamber.

10. A cooling device, comprising:
a first plate;
a second plate coupled to the first plate to form a first outer chamber;
a third plate coupled to the second plate to form an inner chamber;
a fourth plate coupled to the third plate to form a second outer chamber; and
a chamber return having a curved surface, the chamber return coupled to the first plate, the second plate, the third plate, and the fourth plate and configured to direct flow of cooling fluid from the first outer chamber and the second outer chamber to the inner chamber.

11. The cooling device of claim 10, wherein at least one of the first plate or the fourth plate include dimples configured to induce turbulence in a fluid flowing through the first outer chamber and/or the second outer chamber.

12. The cooling device of claim 10, wherein the first outer chamber has a first width, the second outer chamber has a second width, and the inner chamber has a third width, the third width greater than the first width and the second width.

13. The cooling device of claim 10, wherein the first plate is coupled to the second plate via a ridge extending from the first plate.

14. The cooling device of claim 10, wherein the fourth plate is coupled to the third plate via a ridge extending from the fourth plate.

15. A method, comprising:
flowing a first stream of heat transfer fluid via a first flow path along a first plate and a second stream of heat transfer fluid via a second flow path along a second plate, the first plate in physical contact with a first electrochemical cell, the second plate in physical contact with a second electrochemical cell;
converging the heat transfer fluid in the first flow path with the heat transfer fluid in the second flow to form a combined stream;
flowing the combined stream along a common flow path; and
discharging the heat transfer fluid from an outlet port fluidically coupled to the common flow path.

16. The method of claim 15, further comprising:
flowing a precursor stream of heat transfer fluid through an inlet port; and
splitting the precursor stream of heat transfer fluid into the first stream of heat transfer fluid and the second stream of heat transfer fluid.

17. The method of claim 15, wherein the heat transfer fluid includes an inert gas.

18. The method of claim 16, wherein the inlet port is approximately orthogonal to the outlet port.

19. The method of claim 15, wherein the first flow path and the second flow path each include turbulizers.

20. The method of claim 15, wherein the first plate is in physical contact with a first plurality of electrochemical cells, and the second plate is in physical contact with a second plurality of electrochemical cells.
